(19) United States
(12) Patent Application Publication
(10) Pub. No.: US 2010/0183893 A1
(43) Pub. Date: Jul. 22, 2010

(54) CORRUGATED STAINLESS STEEL TUBING WITH SMOOTH BORE

(75) Inventors: Scott Duquette, Enfield, CT (US); Dan Roberts, Mesa, AZ (US); Chris Lukomski, Easthampton, MA (US); Franz Kellar, Gastonia, NC (US); Harold Crowder, Concord, NC (US)

Correspondence Address: EDWARDS ANGELL PALMER & DODGE LLP, P.O. BOX 55874, BOSTON, MA, 02205, US

(73) Assignee: TITEFLEX CORPORATION, Springfield, MA (US)

(21) Appl. No.: 12/531,837

(22) PCT Filed: Mar. 20, 2008
(86) PCT No.: PCT/US08/57607

§ 371 Date: Mar. 17, 2010

Related U.S. Application Data
(60) Provisional application No. 60/919,002, filed on Mar. 20, 2007.

(51) Int. Cl. B32B 1/08; B05D 7/00; B32B 37/00

(52) U.S. Cl. 428/586; 428/34.1; 428/36.9; 427/230; 156/293

(57) ABSTRACT

Corrugated tubing (2) having a smooth or semi-smooth bore, and methods for fabricating such tubing are provided. A length of corrugation tubing (2) can be formed with a filler (4) or liner material inside the tubing. The filler material (4) or liner material may yield one or more improved properties such as reducing head (pressure) loss, reducing friction, sound damping, fire resistance, and corrosion resistance. The corrugated tubing with a smooth or semi-smooth bore can be included in a piping system in which a fitting is connected to the tubing.

### CROSS-REFERENCE TO RELATED APPLICATION

This application claims the benefit of copending application U.S. Provisional Application Ser. No. 60/919,002 filed on Mar. 20, 2007, the disclosure of which is expressly incorporated herein by reference in its entirety.

### FIELD OF INVENTION

The present invention relates to gas, liquid, and slurry piping systems, and more particularly to piping systems incorporating corrugated tubing having a smooth or semi-smooth bore through the use of filler or liner material.

### BACKGROUND OF THE INVENTION

Gas and liquid piping systems which utilize corrugated stainless steel tubing (“CSST”) and fittings are known. Such piping systems can be designed for use in combination with elevated gas pressures of up to about 0.03 megapascals (MPa) or more, and provide advantages over traditional rigid black iron piping systems in terms of ease and speed of installation, elimination of onsite measuring, and reduction in the need for certain fittings such as elbows, tees, and couplings. Undesirably, the corrugations of the tubing can produce vortices in which a backflow causes gas to rotate at the inner walls of the tubing. These vortices result in friction and/or head (pressure) loss as compared to smooth bore pipes.

Moreover, despite the advantages of corrugated tubing, obstacles exist to expanding the use of such tubing beyond gas piping. Corrosion is possible due to the tubing's thin walls, especially where a variety of materials such as liquids or slurries are carried by the corrugated tubing. Corrosion concerns may be exacerbated where the tubing is not installed vertically. For example, where slurry-carrying tubing is installed between floor joists, the solid component of the slurry may collect in the corrugations of the tubing, causes the corrugations to degrade. Even if the slurry does not pose a corrosion risk, the collection of the solid component of the slurry at the bottom of the tubing may obstruct flow, causing head (pressure) loss.

In addition to causing friction and pressure reducing vortices, corrugations may also generate unwanted noise, particularly in high-flow applications.

It would be desirable to provide corrugated tubing that allows for fast, economical installation, while having a smooth or semi-smooth bore that reduces or eliminates head (pressure) loss. It would also be desirable to provide corrugated tubing with an internal structure or material to substantially prevent corrosion of the tubing and/or coagulation of solids in the corrugations of the tubing. Finally, it would be desirable to provide corrugated tubing with sound damping for high-flow applications, where the corrugated tubing also can reduce or eliminate noise created by flow resonance.

### SUMMARY OF THE INVENTION

Corrugated tubing having a smooth or semi-smooth bore, and methods for fabricating such tubing are disclosed. The invention is generally directed to a length of corrugated tubing having a filler or liner material formed inside the tubing. The tubing incorporating the filler or liner material of the present invention preferably has one or more improved properties as compared to prior art corrugated tubing, where such properties include: lower head (pressure) loss, reduced friction, sound damping, fire resistance, and corrosion resistance. The filler of liner material can be made of conductive or insulative materials.

As used herein, the terms “smooth” and “semi-smooth” are used interchangeably, and are only distinguished based on an appearance of the filled or lined tubing, but are not quantitatively or functionally distinguishable. Therefore, a “smooth bore corrugated tube” is considered functionally equivalent to a “semi-smooth bore corrugated tube.”

According to the present invention, a smooth bore corrugated tube includes a length of corrugated tubing and a filler material received inside the length of corrugated tubing. Preferably, the tubing is formed with a plurality of inner corrugation grooves, where the grooves can be filled with the filler material having a substantially smooth surface. The tubing may also be formed with a plurality of inner corrugation lobes, where the lobes may be covered with the filler material in some embodiments.

The corrugated tubing and filler material can have different configurations, and be formed of various materials according to the present invention. For example, the filler material can fill part of the inner corrugation grooves. Alternatively, the filler material may fill all of the inner corrugation grooves. The corrugated tubing may be comprised of a material selected from the group consisting of: thermoplastics, olefin-based plastics, polyethylene, fluorocarbon polymers, polytetrafluoroethylene, metal, metal alloy, stainless steel, carbon steel, copper, brass, aluminum, titanium, nickel, and alloys thereof. The filler material can be a polymer and/or a resin. The filler material can be made of conductive or insulative materials. The filler material may have sound damping, flame retardant, and/or corrosion resistant properties. Preferably, the filler material enhances flow by providing a more smooth flow guide, where the filler material also can serve as a damping medium for absorbing acoustical noise and energy waveforms.

A method for preparing smooth bore corrugated tubing preferably includes providing a length of corrugated tubing and injecting a filler material into the corrugated tubing with an extrusion head. Preferably, the tubing is formed with a plurality of inner corrugation grooves. In various embodiments, the filler material may fill part of the inner corrugation grooves, or alternatively, the filler material may fill all of the inner corrugation grooves. In some embodiments, the filler materials may cover the inner corrugation lobes of the tubing. In other embodiments, the filler material may bridge the corrugation grooves.

Further, the invention relates to a method for preparing smooth bore corrugated tubing including providing a length of rolled and unwelded tubing and installing a previously extruded liner tube inside the tubing prior to final rolling, welding and corrugation forming. The liner tube may be smaller than the bore of the tubing and/or may lie at the bottom of the tubing during welding. Corrugation forming may create a plurality of inner corrugation grooves and a plurality of inner corrugation lobes. The liner tube may contact the inner corrugation lobes. The liner tube may additionally or alternatively be in partial contact with a plurality of inner corrugation grooves.

The present invention also relates to a method for preparing smooth bore corrugated tubing including providing a piece of rolled and welded tubing and pulling a previously extruded liner tube through the tubing. The tubing may be corrugated, resulting in a plurality of inner corrugation grooves and a plurality of inner corrugation lobes, before or after pulling the previously extruded liner tube through the tubing. The liner may contact the inner corrugation lobes. The liner may additionally or alternatively be in partial contact with the corrugation grooves.

The present invention also relates to a piping system including a length of corrugated tubing, a filler material received in the corrugated tubing and a fitting attached to the end of the corrugated tubing. Alternatively, instead of the filler material received in the corrugated tubing, a liner material may be received therein.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views and wherein:

FIG. 1 is a cross-sectional view of the fabrication of a semi-smooth bore corrugated tube in accordance with a preferred embodiment of the present invention;

FIGS. 2(a) to 2(g) are various views of a semi-smooth corrugated tube formed with a liner material in accordance with another preferred embodiment of the present invention;

FIGS. 3(a) to 3(g) are various views of a smooth bore corrugated tube formed with a liner material in accordance with a further preferred embodiment of the present invention;

FIGS. 4(a) to 4(c) are various views of a length of smooth bore corrugated tube fabricated in accordance with a further preferred embodiment of the present invention; and

FIGS. 5(a) and 5(b) are cross sectional views of a length of semi-smooth bore corrugated tube with a fitting attached in accordance with a further preferred embodiment of the present invention.

### DEFINITIONS

The instant invention is most clearly understood with reference to the following definitions:

As used in the specification and claims, the singular form “a”, “an” and “the” include plural references unless the context clearly dictates otherwise.

As used herein, the terms “corrugated stainless steel tubing” and “CSST” refer to any type of tubing or piping, which may accommodate corrosive or aggressive gases or liquids, and includes but is not limited to tubing or piping made from: thermoplastics, metal or metal alloy materials such as olefin-based plastics (e.g., polyethylene (PE)), fluorocarbon polymers (e.g., polytetrafluoroethylene (PTFE)), carbon steel, copper, brass, aluminum, titanium, nickel, and alloys thereof.

### DETAILED DESCRIPTION OF THE INVENTION

Corrugated tubing having a smooth or semi-smooth bore, and methods for fabricating such tubing are disclosed. As used herein, a “smooth bore corrugated tube” and a “semi-smooth bore corrugated tube” are functionally equivalent, but a smooth bore generally indicates the appearance of a consistently smooth filler/liner in the corrugated tube, whereas a semi-smooth bore generally indicates a substantially but not completely smooth filler/liner.

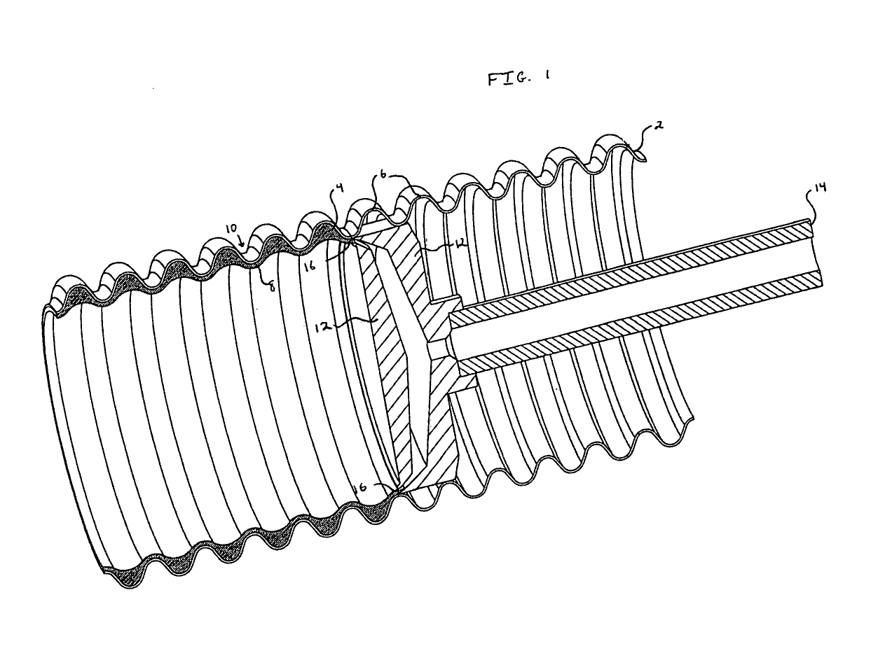

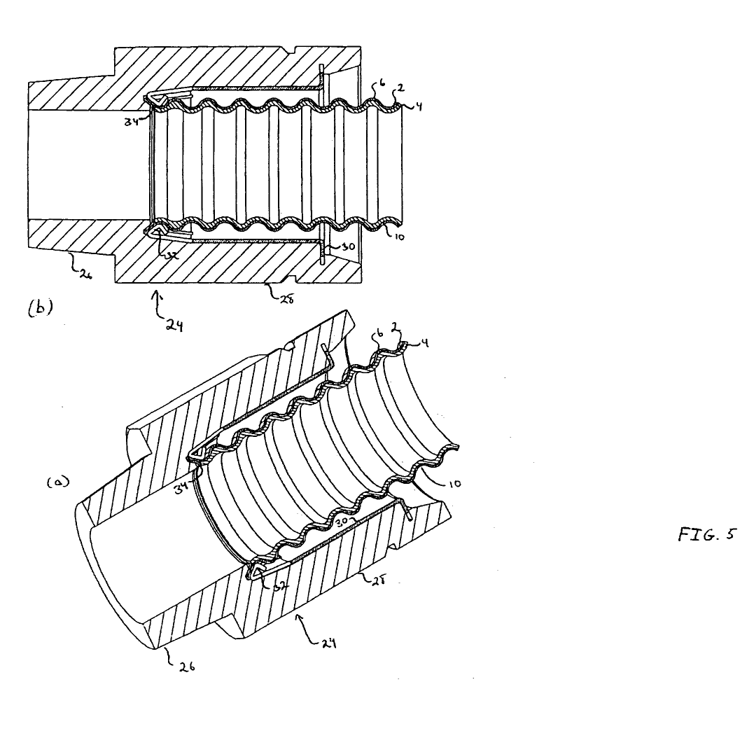

Referring to FIG. 1, a length of corrugated tubing 2 is provided. The corrugated tubing 2 may be composed of stainless steel or any other suitable material. The tubing 2 may be provided with a jacket (not shown) covering the outside of the tubing 2, where the tubing 2 can be at least partially covered with the jacket, and one or more end corrugations optionally may be uncovered to form a seal with a fitting (see, e.g., FIGS. 5(a) and 5(b)). Such jackets can be made from polyethylene or a similar material.

A filler material 4 preferably is applied to an interior of the tubing 2, for example, by injecting the filler material 4 to partially or completely fill the inner corrugation grooves 6 of the tubing. To promote a smooth or semi-smooth bore, the filler material 4 may be formed with a greater thickness in the inner corrugation grooves 6 as compared to inner corrugation lobes 8.

The filler material 4 may be any flexible or semi-flexible material including, but not limited to, polymers and/or resins. The filler material 4 can be made of conductive or insulative materials. In some embodiments, the filler material may have properties such as corrosion resistance and/or flame resistance/retardation. In additional embodiments, the filler material may provide insulation against sound, temperature, and/or vibration. However, the filler material 4 need not necessarily have sound insulating properties to reduce the sound produced by an unlined or unfilled tube. Rather, many filler materials 4 will exhibit less resonance than the metal tubing 2, and therefore produce less sound when fluid flows through the tubing 2 incorporating the filler material 4.

FIG. 1 illustrates the application of filler material 4 to create tubing with a semi-smooth bore. In tubing with a smooth bore, the filler material 4 creates an approximately cylindrical interior shape, that is, the tubing interior has a consistently smooth, cylindrical appearance substantially without the appearance of corrugations; in tubing with a semi-smooth bore, the tubing interior is substantially smooth, but some corrugations may still appear in the tubing. In accordance with the present invention, tubing with either a smooth bore or a semi-smooth bore can reduce head (pressure) loss.

FIG. 1 illustrates a method for fabricating a semi-smooth bore corrugated tube. A guide puck 12 is pulled through a length of formed corrugated tubing 2. The diameter of the guide puck 12 preferably is slightly less than the internal diameter of the tubing 2. The guide puck 12 can be supplied with filler material 4 through an inlet flow tube 14. The inlet flow tube 14 can be actuated to pull the guide puck 12 through the corrugated tubing 2. As shown in FIG. 1, the filler material 4 preferably flows through the inlet flow tube 14, to the guide puck 12, and through one or more vents 16 in the guide puck 12. After leaving the guide puck 12, the filler material 4 contacts the corrugated tubing 2 and forms a smooth or semi-smooth bore. In some embodiments, the vent 16 may be formed in a continuous, circular shape.

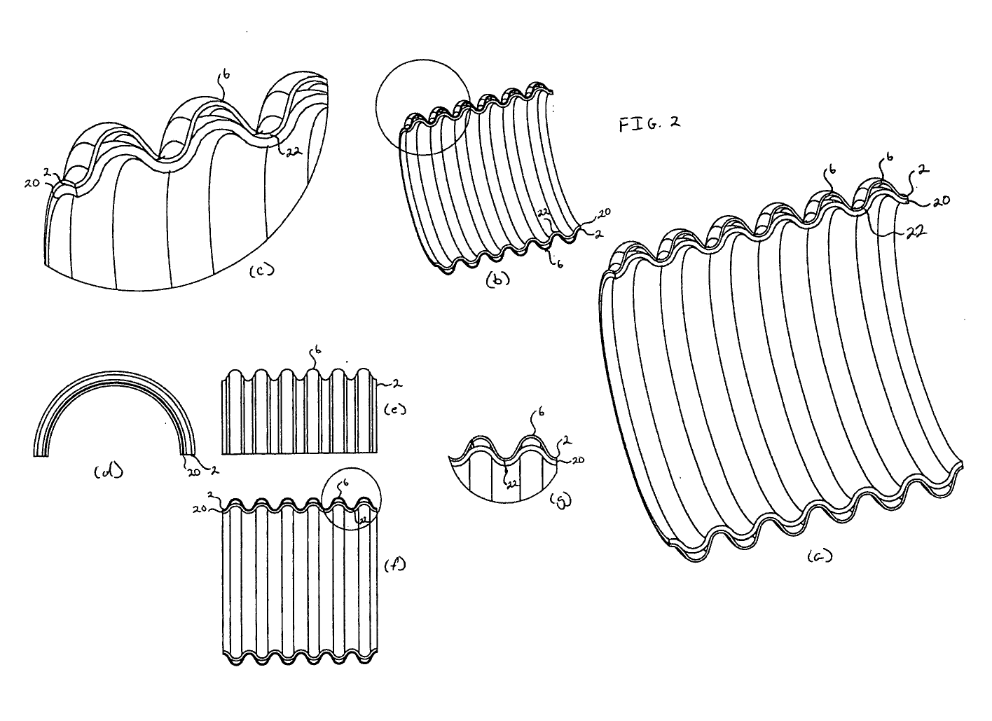

Referring now to FIG. 2(a), another embodiment of semi-smooth bore corrugated tubing is illustrated. As in FIG. 1, a length of tubing 2 is provided. The main difference between FIG. 1 and FIG. 2(a) is the use of a liner material 20 instead of a filler material 4. While the liner material 20 and the filler material 4 may be composed of the same or similar materials and have equivalent properties as described herein, the difference in nomenclature reflects a distinction in how the materials 4 and 20 are applied. While the filler material 4 can contact substantially the entire surface of each inner corrugation groove 6, the liner material 20 generally does not contact the entire surface of each inner corrugation groove 6.

The liner material 20 generally does not contact the entire inner surface of each corrugation 6 because the liner material 20 is formed prior to insertion in the corrugated tubing 2. In one method of installation, the liner material 20 is introduced to the tubing 2 prior to final rolling, welding, and/or corrugation forming. In this method, it may be necessary to distance the liner material 20 from the weld region of the tubing 2 to avoid burning and/or damage of the liner material 20. The liner material 20 may sag due to gravity, achieving the desired separation from the weld region. In other embodiments, a mechanical implement may be used to depress the liner material 20. In still another embodiment, vacuum pressure may be used to collapse the liner material 20 during welding. Once the welding is completed, corrugation forming will create a plurality of inner corrugation lobes 22 with a smaller internal diameter than the inner corrugation grooves 6, and a smaller internal diameter than the external diameter of the liner material 20. Thus, the inner corrugation lobes 22 will constrain the liner material 20.

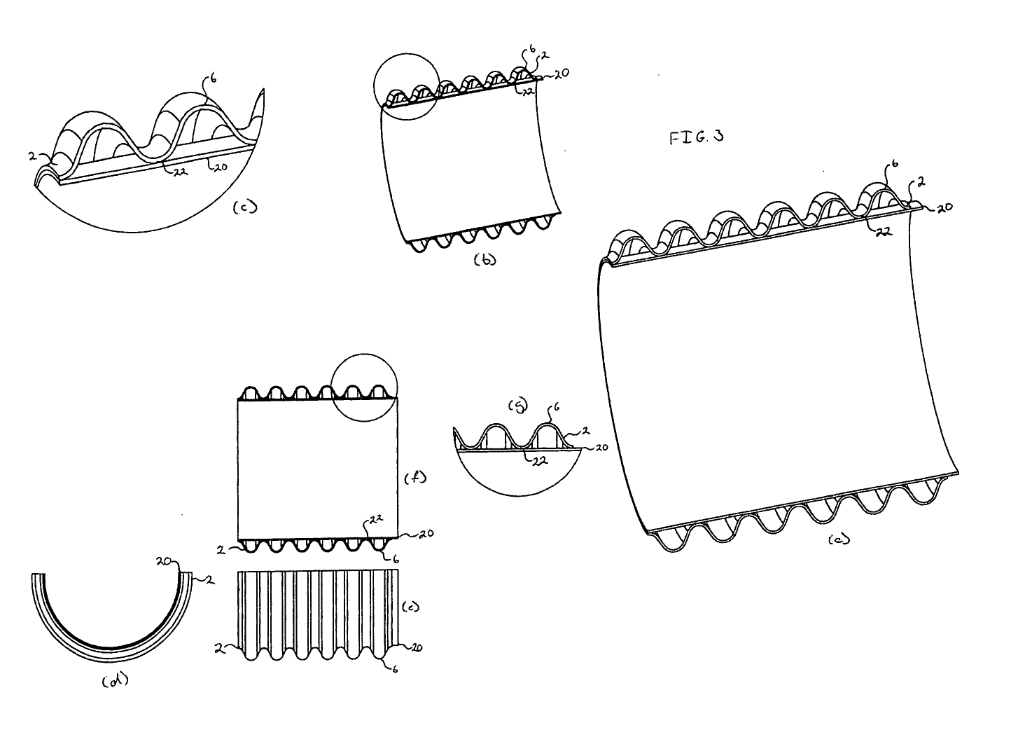

Referring now to FIG. 3(a), an embodiment of smooth bore corrugated tubing is illustrated. Again, a length of corrugated tubing 2 is provided. The liner material 20 preferably contacts the inner corrugation lobes 22, forming a substantially smooth, cylindrical bore.

One method of fabricating the smooth bore corrugated tube illustrated in FIG. 3(a) involves pulling a tube of liner material 20 through a pre-assembled (i.e. welded or joined by other means) length of tubing 2. The tubing 2 may be corrugated before or after the liner material 20 is pulled through the tubing 2.

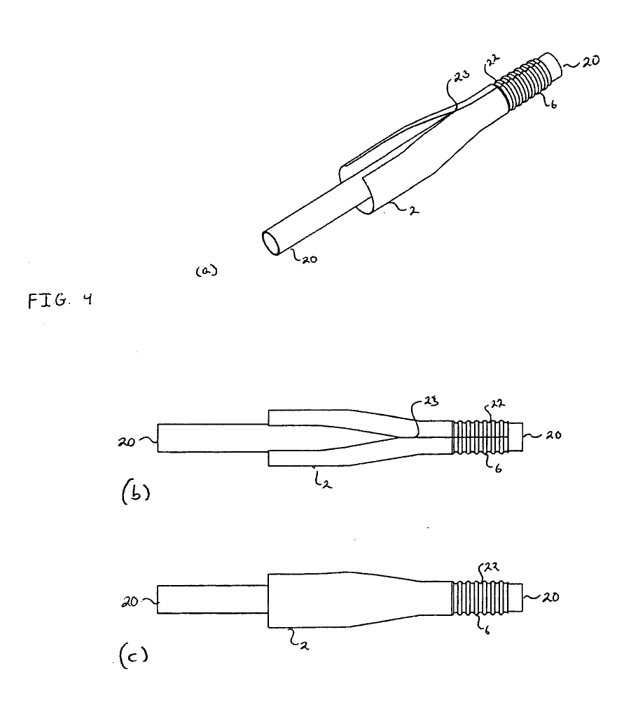

FIGS. 4(a) to 4(c) depict an alternative method of fabrication involving installation of the liner material 20 prior to final rolling, welding, and/or corrugation forming as described herein. FIG. 4(a) schematically shows fabrication of a smooth bore corrugated tube, where the fabrication is incomplete in order to show the various steps of fabrication. Liner material 20 is placed in a length of unwelded tubing 2. The tubing 2 is then welded to form a seal 23. Corrugation forming creates a plurality of corrugation grooves 6 and corrugation lobes 22. The steps described herein may occur serially or in parallel. As an exemplary illustration, a manufacturing apparatus may form smooth bore corrugated tubing by working from one end of the length of tubing 2. As fabrication progresses along the length of tubing, the apparatus places the liner material 20 in the tubing 2, welds the tubing 2, and forms corrugations. In other embodiments, the liner material 20 may be placed inside the entire length of tubing 2 before welding and corrugation forming. The liner material 20 can be made of conductive or insulative materials.

Semi-smooth and smooth bore tubing similar to the embodiments depicted in FIG. 2(a) and FIG. 3(a), respectively, may also be fabricated using a guide puck 12 (see FIG. 1). Similar to FIG. 1, the guide puck 12 can be supplied with liner material through an inlet flow tube 14. The inlet flow tube 14 can be actuated to pull the guide puck 12 through the corrugated tubing 2. The liner material preferably flows through the inlet flow tube 14, to the guide puck 12, and through one or more vents 16 in the guide puck 12. However, in this embodiment, the liner material bridges the inner corrugation grooves 6 of the tubing 2, forming semi-smooth or smooth bore tubing generally similar to the embodiments shown in FIG. 2(a) and FIG. 3(a), respectively.

The present invention also encompasses systems and methods for transporting gas, liquid, and/or slurry through piping or tubing, in which at least a length of the tubing has a smooth or semi-smooth bore. The systems and methods can include transporting the gas, liquid, and/or slurry to or from a device, such as a boiler, furnace, stove, plumbing fixture, or sewerage system. The systems and methods also apply to water transport, chemical transport, and compressed air and other gas delivery systems.

The present invention further encompasses a method for installing a piping or tubing system in a structure, such as a commercial or residential building, where the installation method includes installing at least a length of smooth or semi-smooth bore tubing as provided above.

FIG. 5(a) depicts an embodiment of the invention having a fitting 24 attached to a length of semi-smooth bore tubing 2. Fittings 24 allow for lengths of tubing to be connected to other lengths of tubing, appliances, and other types of pipe. Fittings 24 generally include an adapter portion 26 and a sleeve portion 28. The adapter portion generally interfaces with another fitting, appliance, or other type of pipe, while the sleeve portion 28 generally receives the tubing 2. The sleeve portion 26 preferably is made of metal or a metal alloy, but can be made of other formable materials such as plastics, polymers or elastomers.

The adapter portion 26 and the sleeve portion 28 may be two separate components, which are assembled to form the fitting 24, for example, by using any of a number of common techniques, in order to form a fluid tight seal between the sleeve portion 28 and the adapter portion 26. For example, the sleeve portion can be affixed to the adapter by crimping, or the sleeve portion 28 can be press fit to the outer diameter of the adapter portion 26. Further suitable techniques for connecting the sleeve portion 28 and the adapter portion 26 include brazing and welding. Additionally or alternatively, a compound such as a resin, adhesive, or epoxy can be applied to an interface between the sleeve portion 28 and the adapter portion 26 to form a suitable bond. Optionally, the interface between the sleeve portion 28 and adapter portion 26 can include an O-ring, gasket, or other elastomeric material. Alternatively, the fitting 24 may be formed from a single piece of material as depicted in FIGS. 5(a)-5(b).

Some fittings include a bushing 30 or a collet to engage one or more of the corrugation grooves 10 of the tubing 2. In FIG. 5(a), the bushing 30 has a plurality of fingers 32 to guide the tubing 2 and collapse one or more of the corrugation grooves 10 to form a seal 34.

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications and other references cited herein are hereby expressly incorporated herein in their entireties by reference.

What is claimed is:

1. A smooth bore corrugated tube comprising:
a length of corrugated tubing, the tubing having a plurality of inner corrugation grooves and a plurality of inner corrugation lobes; and
a filler material received in the corrugated tubing, the filler material having a substantially smooth surface.

2. The smooth bore corrugated tube of claim 1, wherein the filler material at least partially fills the inner corrugation grooves.

3. The smooth bore corrugated tube of claim 1, wherein the filler material fills all of the inner corrugation grooves.

4. The smooth bore corrugated tube of claim 1, wherein the filler material covers the inner corrugation lobes.

5. The smooth bore corrugated tube of claim 1, wherein the filler material bridges the inner corrugation grooves.

6. The smooth bore corrugated tube of claim 1, wherein the corrugated tubing comprises a material selected from the group consisting of: thermoplastics, olefin-based plastics, polyethylene, fluorocarbon polymers, polytetrafluoroethylene, metal, metal alloy, stainless steel, carbon steel, copper, brass, aluminum, titanium, nickel, and alloys thereof.

7. The smooth bore corrugated tube of claim 1, wherein the filler material is one selected from the group consisting of: polymer and resin.

8. The smooth bore corrugated tube of claim 1, wherein the corrugated tubing is at least partially surrounded by a jacket.

9. The smooth bore corrugated tube of claim 1, wherein the filler material is configured to provide sound damping.

10. The smooth bore corrugated tube of claim 1, wherein the filler material is substantially flame retardant.

11. The smooth bore corrugated tube of claim 1, wherein the filler material is corrosion resistant.

12. The smooth bore corrugated tube of claim 1, wherein the filler material is conductive or insulative.

13. A method for preparing smooth bore corrugated tubing, the method comprising:
providing a length of corrugated tubing, the tubing having a plurality of inner corrugation grooves and a plurality of inner corrugation lobes; and
injecting a filler material into the corrugated tubing with an extrusion head.

14. The method of claim 13, wherein the filler material fills part of the inner corrugation grooves.

15. The method of claim 13, wherein the filler material fills all of the inner corrugation grooves.

16. The method of claim 13, wherein the filler material covers the inner corrugation lobes.

17. The method of claim 13, wherein the filler material bridges the inner corrugation grooves.

18. The method of claim 13, wherein the filler material is conductive or insulative.

19. A method for preparing smooth bore corrugated tubing, the method comprising the steps of:
providing a length of rolled and unwelded tubing;
installing an extruded liner tube inside the tubing; and
welding the tubing.

20. The method of claim 19, wherein the diameter of the liner tube is smaller than the bore of the tubing.

21. The method of claim 19 further comprising the step of:
forming a plurality of inner corrugation grooves and a plurality of inner corrugation lobes, wherein the liner tube contacts the inner corrugation lobes.

22. The method of claim 21, wherein the liner tube is in partial contact with a plurality of inner corrugation grooves.

23. A method for preparing smooth bore corrugated tubing, the method comprising the steps of:
providing a piece of rolled and welded tubing; and
pulling a previously extruded liner tube through the tubing.

24. The method of claim 23, wherein the tubing is corrugated, resulting in a plurality of inner corrugation grooves and a plurality of inner corrugation lobes, before pulling the previously extruded liner tube through the tubing.

25. The method of claim 24, wherein the liner tube contacts the inner corrugation lobes.

26. The method of claim 24, wherein the liner tube is in partial contact with the corrugation grooves.

27. The method of claim 23, wherein the tubing is corrugated, resulting in a plurality of inner corrugation grooves and a plurality of inner corrugation lobes, after pulling the previously extruded liner tube through the tubing.

28. The method of claim 27, wherein the liner tube contacts the inner corrugation lobes.

29. The method of claim 27, wherein the liner tube is in partial contact with the corrugation grooves.

30. The method of claim 27, wherein the liner tube is conductive or insulative.

31. A piping system comprising:
a length of corrugated tubing, the tubing having a plurality of inner corrugation grooves and a plurality of inner corrugation lobes;
a filler material received in the corrugated tubing, the filler material having a substantially smooth surface; and
a fitting operably connected to the length of corrugated tubing.

32. A piping system comprising:
a length of corrugated tubing, the tubing having a plurality of inner corrugation grooves and a plurality of inner corrugation lobes;
an extruded liner tube arranged inside the tubing; and
a fitting operably connected to the length of corrugated tubing.
